(19) United States
(12) Patent Application Publication
(10) Pub. No.: US 2002/0125982 A1
(43) Pub. Date: Sep. 12, 2002

(54) SURFACE MOUNT ELECTRICAL DEVICE WITH MULTIPLE PTC ELEMENTS

(76) Inventors: ROBERT SWENSEN, MOUNT PROSPECT, IL (US); HONORIO LUCIANO, ELK GROVE VILAGE, IL (US)

Correspondence Address: JEFFREY R GARGANO, WALLENSTEIN AND WAGNER LTD, 53RD FLOOR, 311 SOUTH WACKER DRIVE, CHICAGO, IL, 606066622

(21) Appl. No.: 09/361,849

(22) Filed: Jul. 27, 1999

Related U.S. Application Data
(60) Provisional application No. 60/094,434, filed on Jul. 28, 1998.

(51) Int. Cl. H01C 7/10

(52) U.S. Cl. 338/22 R

(57) ABSTRACT

A surface-mountable electrical circuit protection device comprising first and second laminar PTC elements, each having first and second surfaces. The PTC elements are electrically connected in parallel. A first electrode is attached to the first of the first PTC element and a second electrode is attached to the second surface of the second PTC element. A third electrode, having an electrical resistance is positioned between the first and second laminar PTC elements. The third electrode is connected to the second surface of the first PTC element and the first surface of the second PTC element and has a main portion and a sub-portion. The main portion of the third electrode is separated from the sub-portion by an element having a higher electrical resistance than the electrical resistance of the third electrode. A first electrically conductive end termination wraps around a first end of the device and is in electrical contact with the first and second electrodes. A second electrically conductive end termination wraps around a second end of the device and is in electrical contact with the third electrode. The stacked configuration of the PTC elements allows for an increased electrical rating without increasing the overall footprint, i.e., length and width, of the device.

### CROSS REFERENCE TO RELATED APPLICATIONS

This Application claims the benefit of U.S. Provisional Application No. 60/094,434, filed Jul. 28, 1998, the disclosure of which is incorporated herein by reference.

### TECHNICAL FIELD

The present invention relates generally to a surface mountable electrical circuit protection device and specifically to a multi-layer PTC configuration for higher rated circuit protection devices.

### BACKGROUND OF THE INVENTION

It is well known that the resistivity of many conductive materials change with temperature. Resistivity of a positive temperature coefficient (“PTC”) material increases as the temperature of the material increases. Many crystalline polymers, made electrically conductive by dispersing conductive fillers therein, exhibit this PTC effect. These polymers generally include polyolefins such as polyethylene, polypropylene and ethylene/propylene copolymers. Certain doped ceramics such as barium titanate also exhibit PTC behavior.

At temperatures below a certain value, i.e., the critical or switching temperature, the PTC material exhibits a relatively low, constant resistivity. However, as the temperature of the PTC material increases beyond this point, the resistivity sharply increases with only a slight increase in temperature.

Electrical devices employing polymer and ceramic materials exhibiting PTC behavior have been used as overcurrent protection in electrical circuits. Under normal operating conditions in the electrical circuit, the resistance of the load and the PTC device is such that relatively little current flows through the PTC device. Thus, the temperature of the device due to I²R heating remains below the critical or switching temperature of the PTC device. The device is said to be in an equilibrium state (i.e., the rate at which heat is generated by I²R heating is equal to the rate at which the device is able to lose heat to its surroundings).

If the load is short circuited or the circuit experiences a power surge, the current flowing through the PTC device increases and the temperature of the PTC device (due to I²R heating) rises rapidly to its critical temperature. At this point, a great deal of power is dissipated in the PTC device and the PTC device becomes unstable (i.e., the rate at which the device generates heat is greater than the rate at which the device can lose heat to its surroundings). This power dissipation only occurs for a short period of time (i.e., a fraction of a second), however, because the increased power dissipation will raise the temperature of the PTC device to a value where the resistance of the PTC device has become so high that the current in the circuit is limited to a relatively low value. This new current value is enough to maintain the PTC device at a new, high temperature/high resistance equilibrium point, but will not damage the electrical circuit components. Thus, the PTC device acts as a form of a fuse, reducing the current flow through the short circuit load to a safe, relatively low value when the PTC device is heated to its critical temperature range. Upon interrupting the current in the circuit, or removing the condition responsible for the short circuit (or power surge), the PTC device will cool down below its critical temperature to its normal operating, low resistance state. The effect is a resettable, electrical circuit protection device.

### SUMMARY OF THE INVENTION

The present invention provides an electrical circuit protection device having an increased electrical rating by increasing the active area the PTC element while keeping the same footprint, i.e., length and width, of the device. Typically, to increase the electrical rating of a device, the area of the PTC element must be increased. Rather than expanding the overall dimensions of the device, the present invention employs at least two PTC elements stacked on top of one another and electrically connected in parallel to increase the active PTC area. The result is a device with the same footprint, but an increased electrical rating.

In a first embodiment there is provided a surface-mountable electrical circuit protection device comprising first and second laminar PTC elements, each having first and second surfaces. The PTC elements are electrically connected in parallel. A first electrode is attached to the first of the first PTC element and a second electrode is attached to the second surface of the second PTC element. A third electrode is positioned between the first and second laminar PTC elements and has an electrical resistance. The third electrode is connected to the second surface of the first PTC element and the first surface of the second PTC element and has a main portion and a sub-portion. The main portion of the third electrode is separated from the sub-portion by an element having a higher electrical resistance than the electrical resistance of the third electrode. A first electrically conductive end termination wraps around a first end of the device and is in electrical contact with the first and second electrodes. A second electrically conductive end termination wraps around a second end of the device and is in electrical contact with the third electrode. The first and second end terminations are electrically separated by an insulator.

In a second embodiment of the present invention there is a surface-mountable electrical circuit protection device comprising two PTC elements electrically connected in parallel. The first PTC element has first and second electrodes attached to opposite surfaces thereof. The second PTC element also has first and second electrodes attached to opposite surfaces thereof. A conductive member physically connects the first and second PTC elements to form a laminate with first and second ends. The laminate includes first and second outer electrodes, first and second PTC elements, and first and second inner electrodes connected by the conductive member. A first insulator covers the first end of the laminate. A second insulator covers the second end of the laminate except for at least one of the following: the conductive member and the first and second inner electrodes. A first conductive end termination is formed on the first insulator and makes electrical contact with the first and second outer electrodes of the laminate. A second conductive end termination is formed on the second insulator and makes electrical contact with at least one of the following: the conductive member and the first and second inner electrodes of the laminate.

In a third embodiment of the present invention a first PTC element having first and second conductive end terminations is electrically connected in parallel with a second PTC element having third and fourth conductive end terminations. The first end termination of the first PTC element is electrically and physically connected to the third end termination of the second PTC element by a conductive member. Similarly, the second end termination of the first PTC element is electrically and physically connected to the fourth end termination of the second PTC element by a conductive member.

### BRIEF DESCRIPTION OF THE DRAWINGS

A better understanding of the present invention will be had upon reference to the following detailed description and accompanying drawings. The size and thickness of the various elements illustrated in the drawings has been greatly exaggerated to more clearly show the electrical devices of the present invention.

FIG. 1 is a front view of an electrical device according to a first embodiment of the present invention.

FIG. 2 is a front view of an electrical device according to a second embodiment of the present invention.

FIG. 3 is a front view of an electrical device according to a third embodiment of the present invention.

FIG. 4 is a partial exploded view of the components to be laminated in the method of making the device illustrated in FIG. 1.

FIG. 5 is a front view of a laminate formed during the process of manufacturing the device illustrated in FIGS. 1 and 4.

### DETAILED DESCRIPTION OF THE INVENTION

While this invention is susceptible of embodiment in many different forms, there is shown in the drawings and will herein be described in detail preferred embodiments of the invention with the understanding that the present disclosure is to be considered as an exemplification of the principles of the invention.

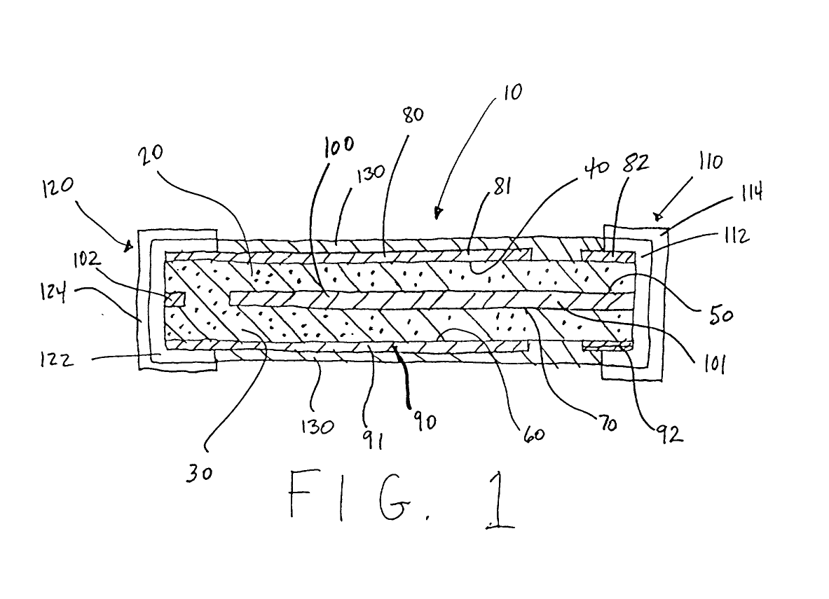

### EMBODIMENT ILLUSTRATED IN FIGS. 1, 4 AND 5

FIG. 1 illustrates a first embodiment of an electrical device 10 according to the present invention. The device 10 is comprised of first and second PTC elements 20,30 electrically connected in parallel, first, second and third electrodes 80,90,100 and first and second end terminations 110,120.

Generally, the PTC elements 20,30 are composed of a PTC composition comprised of a polymer component and a conductive filler component. The polymer component may comprise a polyolefin having a crystallinity of at least 40%. Suitable polymers include polyethylene, polypropylene, polybutadiene, polyethylene acrylates, ethylene acrylic acid copolymers, and ethylene propylene copolymers. In a preferred embodiment, the polymer component comprises polyethylene and maleic anhydride, e.g., Fusabond™ manufactured and sold by DuPont. The conductive filler is dispersed throughout the polymer component in an amount sufficient to ensure that the composition exhibits PTC behavior. Alternatively, the conductive filler can be grafted to the polymer component.

Generally, the conductive filler component will be present in the PTC composition by approximately 25-75% by weight. Suitable conductive fillers to be used in the present invention include powders, flakes or spheres of the following metals: nickel, silver, gold, copper, silver-plated copper, or metal alloys. The conductive filler may also comprise carbon black, carbon flakes or spheres, or graphite. Particularly useful PTC compositions have a resistivity at 25° C. of less than 5 ohm cm, especially less than 3 ohm cm, and preferably less than 1 ohm cm, e.g., 0.1 ohm cm. Suitable PTC compositions for use in the present invention are disclosed in U.S. patent application Ser. No. 08/614,038 and U.S. Pat. Nos. 4,237,441, 4,304,987, 4,849,133, 4,880,577, 4,910,389 and 5,190,697, the disclosures of which are incorporated herein by reference.

The first PTC element 20 has first and second opposed surfaces 40,50. The first electrode 80 is attached to the first surface 40 of the first PTC element 20. The second PTC element 30 has first and second opposed surfaces 60,70. The second electrode 90 is attached to the second surface 70 of the second PTC element 30.

The third electrode 100 has an electrical resistance, R, and is positioned between the first and second PTC elements 20,30. The third electrode 100 is connected to the second surface 50 of the first PTC element 20 on one side and to the first surface 60 of the second PTC element 30 on the other side.

Each of the electrodes have a main portion and a sub-portion: the first electrode 80 has a main portion 81 and a sub-portion 82; the second electrode 90 has a main portion 91 and a sub-portion 92; and the third electrode 100 has a main 101 and a sub-portion 102. As will be explained further below, the main portions and the sub-portions of the electrodes are physically separated by material having a greater electrical resistance in order to direct flow of electrical current through the device.

In the preferred embodiment, the electrodes are comprised of a metal foil, especially metal foils having microrough surfaces such as those disclosed in U.S. Pat. Nos. 4,689,475 and 4,800,253, the disclosures of which are incorporated herein by reference. It is to be understood, however, that the electrodes may be composed of any conventional electrode material, including a conductive layer applied to the surfaces of the PTC elements by conventional methods, e.g, electroless plating, electrolytic plating, vapor deposition, sputtering, etc.

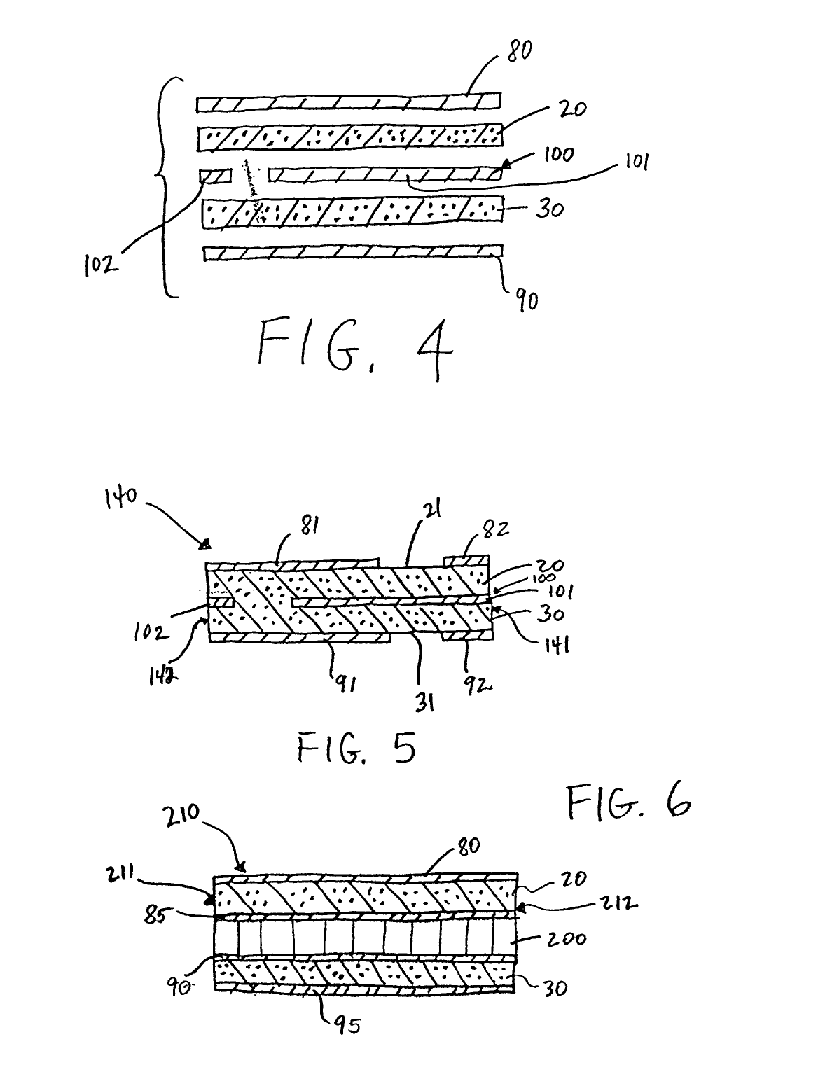

With reference to FIG. 4, in a preferred method, the electrodes 80,90,100 and the PTC elements 20,30 are placed in a heated press to form a sandwich or laminate. As shown in FIG. 4, the third electrode 100 is already separated into its main portion 101 and its sub-portion prior to being laminated between the first and second PTC elements 20,30. Once laminated, the main portions and sub-portions of the first and second electrodes 80,90 are formed by either conventional masking and etching or the photo lithographic process disclosed in U.S. Pat. No. 5,699,607, the disclosure of which is incorporated herein by reference. The resulting laminate 140 is illustrated in FIG. 5. The first and second PTC elements 20,30 are physically joined between the sub-portion 102 and the main portion 101 of the third electrode 100.

In the next step, electrically conductive end terminations 110,120 are applied to opposite ends 141,142 of the laminate 140. The first end termination 110 wraps around end 141 and makes electrical contact and preferably physical contact with the sub-portions 82,92 of first and second electrodes 80,90, and the main portion 101 of the third electrode 100. The second end termination 120 wraps around end 142 and makes electrical and preferably physical contact with the sub-portion 102 of the third electrode 100, and the main portions 81,91 of the first and second electrodes 80,90.

In a preferred method, the end terminations 110,120 are formed by first applying a photo resist layer 130 (or dielectric material) over the laminate 140. The areas to be covered by the end terminations 110,120 are imaged and developed to define the end terminations. The developed photo resist layer 130 covers the first and second electrodes 80,90 and the exposed portions of the first and second PTC elements 21,31. The first and second end terminations 110,120 are then formed by plating the defined areas with a first conductive material 112,122, respectively. In a preferred embodiment, the first conductive layers 112,122 of the end terminations 110,120 are copper. Finally, in a more preferred embodiment, second conductive layers 114,124, preferably a mixture of tin and lead, are applied to the first conductive layers 112,122 of the end terminations 110,120, respectively.

When mounted to conductive terminals on a printed circuit board, electrical current may flow in through either end termination 110,120. For example, current entering the device through first end termination 120 will flow to the main portions 81,91 of first and second electrodes 80,90. The current flowing along the main portion 91 of the second electrode 90 will continue through the second PTC element 30 to the main portion 101 of the third electrode 100. The current flowing along the main portion 81 of the first electrode 80 will continue through the first PTC element 20 to the main portion 101 of the third electrode 100. Once the current passes through the PTC elements 20,30 and is collected along the main portion 101 of the third electrode 100, it exits the device 10 through the second end termination 110.

Alternatively, current may enter the device 10 through end termination 110, flow along the main portion 101 of the third electrode 100, through PTC elements 20,30 to the main portions 81,91 of electrodes 80,90 and out through end termination 120.

The separation of the main portions and the sub-portions of the electrodes by more resistive materials, e.g., dielectric or a photo resist material separates the main portions and sub-portions of the first and second electrode 80,90, while the first and second PTC elements 20,30 migrate during the lamination process and fill the void between the main portion and the sub-portion of the third electrode 100, dictates current flow through the device. This separation of the electrodes prevents current from flowing circularly around the PTC elements, and instead, directs current flow in parallel through the PTC elements. Accordingly, by stacking two or more PTC elements on top of one another in this configuration, a higher rated surface mount device can be achieved without increasing the length and width, i.e., the footprint, of the device.

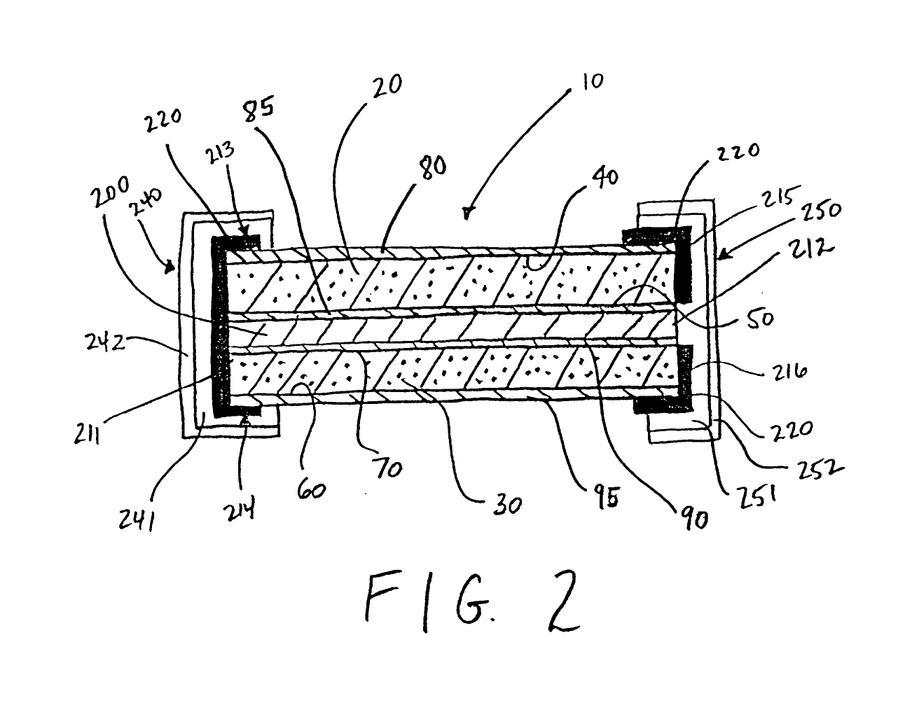

### EMBODIMENT ILLUSTRATED IN FIGS. 2 AND 6

FIG. 2 illustrates a second embodiment of the device 10 according to the present invention. The device 10 includes first and second PTC elements 20,30. The first PTC element 20 has electrodes 80,85 attached to opposed surfaces 40,50. The second PTC element 30 has electrodes 90,95 attached to opposed surfaces 60,70. The materials for the PTC elements 20,30 and the electrodes 80,85,90,95 are the same as mentioned above with respect to the embodiment illustrated in FIGS. 1, 4 and 5.

A conductive member 200 connects the first and second PTC elements 20,30 to form a laminate 210. Conductive member 200 may be formed from any conductive material which will form an adhesive bond connecting the PTC elements via electrodes 85,90; e.g., a highly conductive polymer, a conductive thick film ink or solder. The laminate 210 is illustrated in FIG. 6. Insulative layers 220 are applied to opposite ends 211,212 of the laminate 210. At one end 211, the insulative layer 220 covers the entire end of the laminate 210. Preferably the insulating layer 220 wraps around the top and bottom of the laminate covering a portion of the first electrode 80 of the first PTC element 20 (shown by reference numeral 213) and a portion of the second electrode 95 of the second PTC element 30 (shown by reference numeral 214). This overlapping of electrodes 80,95 helps prevent shorting of the device.

At the other end 212 of the laminate 210, the insulative layer 220 covers the first electrode 80 and the first PTC element 20 (shown by reference number 215) and the second electrode 95 and the second PTC element 30 (shown by reference numeral 216). As illustrated, these portions of the insulative layer 220 are L-shaped. At least one of the following elements is not covered by the insulative layer at end 212: the conductive member 200, electrode 85 or electrode 95. In a preferred embodiment (shown in FIG. 2), the conductive member 200, and electrodes 85,95 are left exposed by insulative layer 220 to provide an electrical connection to the end termination (as is discussed below).

A first conductive end termination 240 is formed on the insulative layer 220 at end 211. The end termination 240 wraps around the end 211 of the device 10 and makes electrical contact with the first electrode 80 of the first PTC element 20 and the second electrode 95 of the second PTC element 30. In this manner, the end termination 240 extends beyond the insulative layer 220. Preferably, the end termination 240 is comprised of a first conductive layer 241 of copper and a second conductive layer 242 of tin/lead mixture.

A second conductive end termination 250 is formed on the insulative layer 220 at end 212. The end termination 250 makes electrical contact with at least one of the following elements: the conductive member 200, electrode 85, or electrode 90. In order to ensure a good electrical connection, preferably, the end termination 250 makes electrical and physical contact with the conductive member 200 and electrodes 85,90. The end termination 250 is comprised of first and second conductive layers 251,252 (preferably copper and tin/lead mixture, respectively).

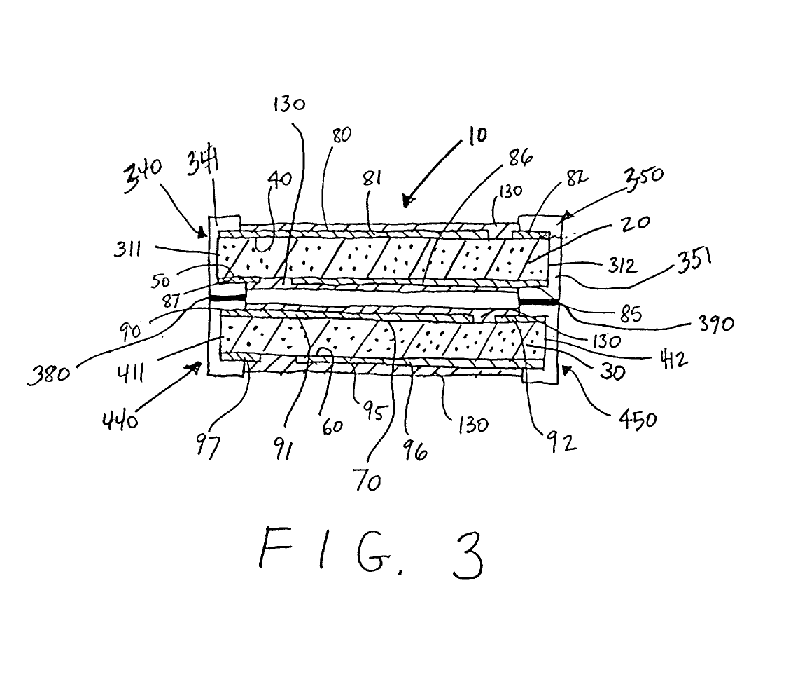

### EMBODIMENT ILLUSTRATED IN FIG. 3

A third embodiment of a device 10 according to the present invention is illustrated in FIG. 3. The device 10 comprises a first PTC element 20 electrically connected in parallel with a second PTC element 30.

The first PTC element 20 has first and second electrodes 80,85 attached to opposed surfaces 40,50 thereof. Similar to the embodiment illustrated in FIGS. 1, 4 and 5, the electrodes 80,85 have main portions 81,86 and sub-portions 82,87 separated by an insulator 130. First and second conductive end terminations 340,350 wrap around opposite ends 311,312 of the PTC element 20. The first end termination 340 makes electrical contact with the main portion 81 of electrode 80 and the sub-portion 87 of electrode 85. The second end termination 350 makes electrical contact with the sub-portion 82 of electrode 80 and the main portion 86 of electrode 85. The first and second end terminations 340, 350 are separated by the insulator 130.

The second PTC element 30 has third and fourth electrodes 90,95 attached to opposed surfaces 60,70 thereof. Like the first and second electrodes, the third and fourth electrodes have a main portion 91,96 and a sub-portion 92,97 separated by an insulator 130. Third and fourth conductive end terminations 440,450 wrap around opposite ends 411,412 of the PTC element 30. The third end termination 440 makes electrical contact with the main portion 91 of electrode 90 and the sub-portion 97 of electrode 95. The fourth end termination 450 makes electrical contact with the sub-portion 92 of electrode 90 and the main portion 96 of electrode 95. The third and fourth end terminations 440,450 are separated by the insulator 130.

The first end termination 340 of the first PTC element 20 is electrically and physically connected to the third end termination 440 of the second PTC element 30 by a conductive member 380. Likewise, the second end termination 350 of the first PTC element 20 is electrically and physically connected to the fourth end termination 450 of the second PTC element 30 by a conductive member 390. Preferably, conductive members 380,390 comprise solder.

When electrically connected to terminal pads on a printed circuit board, current may enter through any of the four end terminations 340,350,440,450. With reference to the configuration illustrated in FIG. 3, current may enter through end termination 440 and travel along main portions 81,91 of electrodes 80,90, through PTC elements 20,30 to main portions 86,96 of electrodes 85,95 and out through end terminations 350,450. The device 10 essentially has a piggyback configuration with PTC element 20 electrically connected in parallel with PTC element 30 which allows for a higher rated device without increasing the footprint of the device.

What is claimed is:

1. A surface-mountable electrical circuit protection device comprising:
a first PTC element having first and second surfaces, a first electrode attached to the first surface;
a second PTC element having first and second surfaces, a second electrode attached to the second surface;
a third electrode positioned between the first and second laminar PTC elements and having an electrical resistance, the third electrode connected to the second surface of the first PTC element and the first surface of the second PTC element and having a main portion and a sub-portion, the main portion being separated from the sub-portion by an element having a higher electrical resistance than the electrical resistance of the third electrode;
a first electrically conductive end termination wrapping around a first end of the device and electrically contacting the first and second electrodes; and
a second electrically conductive end termination wrapping around a second end of the device and electrically contacting the third electrode.

2. The device of claim 1, wherein the first and second electrodes comprise a main portion and a sub-portion.

3. The device of claim 2, wherein the main portions of the first and second electrodes are physically and electrically separated from the sub-portions, respectively.

4. The device of claim 1, wherein the first and second PTC elements are physically joined between the sub-portion and the main portion of the third electrode.

5. The device of claim 1, wherein the electrodes are comprised of a metal foil.

6. The device of claim 1, wherein the first and second PTC elements are comprised of a conductive polymer.

7. The device of claim 1, wherein the first end termination is in direct contact with the sub-portions of the first and second electrodes and the main portion of the third electrode.

8. The device of claim 1, wherein second end termination is in direct contact with the sub-portion of the third electrode and the main portions of the first and second electrodes.

9. The device of claim 1, wherein the first and second end terminations are comprised of first and second conductive layers.

10. The device of claim 1 further comprising an electrically insulating layer deposited on the first and second electrodes between the first and second end terminations.

11. The device of claim 10, wherein the electrically insulating layer is in direct contact with the first PTC element between the main portion and the sub-portion of the first electrode and is in direct contact with the second PTC element between the main portion and the sub-portion of the second electrode.

12. A surface-mountable electrical device having a first PTC element electrically connected in parallel to a second PTC element, said device comprising:
a first PTC element having first and second electrodes attached to opposite faces thereof, the first and second electrodes having a main portion and a sub-portion, respectively;
a first end termination wrapping around a first end of the first PTC element and making electrical contact with the sub-portion of the first electrode and the main portion of the second electrode;
a second end termination wrapping around a second end of the first PTC element and making electrical contact with main portion of the first electrode and the sub-portion of the second electrode;
a second PTC element having third and fourth electrodes attached to opposite faces thereof, the third and fourth electrodes having a main portion and a sub-portion, respectively;
a third end termination wrapping around a first end of the second PTC element and making electrical contact with the sub-portion of the third electrode and the main portion of the fourth electrode;
a fourth end termination wrapping around a second end of the second PTC element and making electrical contact with the main portion of the third electrode and the sub-portion of the fourth electrode; and
an electrically conductive member connecting the first and third end terminations and the second and fourth end terminations, respectively.

13. A surface-mountable electrical device having a first PTC element electrically connected in parallel to a second PTC element, said device comprising:
the first PTC element having first and second electrodes attached to opposed surfaces thereof, the first and second electrodes having a main portion and a sub-portion separated by an insulating member, first and second end terminations wrapping around opposite ends of the PTC element, respectively, the first end termination contacting the main portion of the first electrode and the sub-portion of the second electrode, the second end termination contacting the sub-portion of the first electrode and the main portion of the second electrode;
the second PTC element having third and fourth electrodes attached to opposed surfaces thereof, the third and fourth electrodes having a main portion and a sub-portion separated by an insulating member, third and fourth end terminations wrapping around opposite ends of the second PTC element, respectively, the third end termination contacting the main portion of the third electrode and the sub-portion of the fourth electrode, the fourth end termination contacting the sub-portion of the third electrode and the main portion of the fourth electrode; and
the first and second end terminations being electrically and physically connected to the third and fourth end terminations, respectively, such that the first and second PTC elements are electrically connected in parallel.

14. A surface-mountable electrical circuit protection device comprising:
a first PTC element having first and second electrodes attached to opposite surfaces thereof;
a second PTC element having first and second electrodes attached to opposite surfaces thereof;
a conductive member physically connecting the first and second PTC elements to form a laminate, the laminate having first and second ends;
a first insulator deposited on the first end of the laminate,
a second insulator deposited on the second end of the laminate;
a first conductive end termination deposited on the first insulator and making electrical contact with one of the following:
(i) the first electrode of the first PTC element and the second electrode of the second PTC element;
(ii) the second electrode of the first PTC element and the first electrode of the second PTC element; or
(iii) the conductive member; and
a second conductive end termination deposited on the second insulator and making electrical contact with one of the following which is not in electrical contact with the first conductive end termination:
(i) the first electrode of the first PTC element and the second electrode of the second PTC element;
(ii) the second electrode of the first PTC element and the first electrode of the second PTC element; or
(iii) the conductive member.

15. The device of claim 14, wherein the first and second PTC elements are comprised of a polymer having conductive particles dispersed therein.

16. The device of claim 15, wherein the conductive member is comprised of a material selected from the group including a conductive polymer, a conductive thick film ink, solder, and a conductive adhesive.

17. The device of claim 15, wherein the first end termination is in direct contact with one of the first and second electrodes of the first PTC element and one of the first and second electrodes of the second PTC element.

18. The device of claim 17, wherein the first insulator electrically separates the first end termination from the other of the first and second electrodes of the first PTC element, the conductive member, and the other of the first and second electrodes of the second PTC element.

19. The device of claim 17, wherein the second insulator electrically separates the second end termination from the electrodes which are in direct contact with the first end termination.

20. The device of claim 15, wherein the first end termination is in direct contact with the conductive member.

21. The device of claim 19, wherein the first insulator electrically separates the first end termination from the first electrode of the first PTC element and the second electrode of the second PTC element.

22. The device of claim 19, wherein the second insulator electrically separates the second end termination from the second electrode of the first PTC element and the first electrode of the second PTC element.
